(19) United States
(12) Patent Application Publication
(10) Pub. No.: US 2008/0091373 A1
(43) Pub. Date: Apr. 17, 2008

(54) Method for calibrating sensor positions in a human movement measurement and analysis system

(75) Inventors: Chris McGibbon, Fredericton (CA); Andrew Sexton, Douglas (CA); David Krebs, Cambridge, MA (US)

Correspondence Address: Ralph A. Dowell of DOWELL & DOWELL P.C., 2111 Eisenhower Ave, Suite 406, Alexandria, VA, 22314, US

(73) Assignee: University of New Brunswick, Frederiction (CA)

(21) Appl. No.: 11/882,082

(22) Filed: Jul. 30, 2007

Related U.S. Application Data
(60) Provisional application No. 60/834,158, filed on Jul. 31, 2006.

(51) Int. Cl. G06F 19/00; G01P 21/00

(52) U.S. Cl. 702/95; 702/153

(57) ABSTRACT

A method for calibrating the position and orientation of a 6-DOF sensor system mounted on a multi-segmented structure, such as the human body, is provided. The method includes a stage for mounting the sensors on the body, a stage for acquiring the 6-DOF kinematics from those sensors, a calibration stage whereby the prior stages are used to determining the sensor-to-segment transformations that are most physiologically optimal during relative skeletal motions, and a stage that to periodically monitor and correct for sensor slippage.

### CROSS REFERENCE TO RELATED U.S PATENT APPLICATIONS

This patent application relates to U.S. provisional patent application Ser. No. 60/834,158 filed on Jul. 31, 2006 entitled METHOD FOR CALIBRATING SENSOR POSITIONS IN A HUMAN MOVEMENT MEASUREMENT AND ANALYSIS SYSTEM, filed in English, which is incorporated herein in its entirety by reference.

### FIELD OF INVENTION

The present invention relates generally to a method for determining the six fixed independent coordinates (3 displacements and 3 rotations) of body surface mounted motion sensors relative to the underlying skeletal frame, for the purpose of capturing six degree of freedom (6-DOF) kinematic and kinetic information of human skeletal motion, and for analyzing the information in an anatomically and physiologically meaningful way.

### BACKGROUND OF THE INVENTION

Human movement analysis began formally at the end of the 19^{th} century with the advent of cinematography, and its application to capturing animal motion by pioneers such as Eadweard Muybridge (1830-1904) and Étienne-Jules Marey (1830-1904). Unlike early motion capture systems, modern video and optoelectric human movement capture systems are accurate, reliable and fast, and have applications spanning the clinical and biomedical sciences, sport sciences and entertainment industries. While the goals of these different fields of application may vary considerably: eg. natural looking or contrived motion for entertainment industry versus accurate and objective motion data for clinical assessment, the underlying principles of motion tracking apply equally to all fields.

The preferred method of tracking any multi-segmented structure (such as a human or animal) is to track the six degree of freedom (6-DOF) kinematics of each segment independently. There are numerous ways this can be accomplished, as taught by those skilled in the art. A cluster comprising three or more light reflective markers or light emitting diodes can be placed on the skin of body segments, or placed on rigid plates which are then attached to body segments, and their 3D positions tracked in space by video or optoelectric cameras. Another approach is to place magnetic field sensors on each body segment within an induced magnetic field. Another approach again is to use microelectronic “MEMS” motion sensors, such as accelerometers and gyroscopes, to estimate the 6-DOF kinematics of the body segments (3-DOF plus a model). These technologies all fall into the category of surface mounted sensor systems (“sensor system”) capable of measuring directly or indirectly 6-DOF kinematics.

However, to obtain both physiologically meaningful and clinically useful data describing human movements, one needs to track the 6-DOF motion of the underlying skeleton. Given that we are currently limited to surface mounted technologies, we are forced to track the skeleton by inference, and as such, we use the surface mounted sensors to infer the underlying skeletal motions. As known to those skilled in the art, this is accomplished using a mathematical “transformation” that translates the 6-DOF sensor information into 6-DOF skeletal movements. This requirement is independent of the 6-DOF system selected for tracking skeletal motion.

### REVIEW OF RELATED ART

While different sensor systems have unique artifacts and sources of error, virtually all body surface mounted technologies suffer from errors due to soft tissue movement. Various approaches have been taken to compensate for this naturally occurring artifact, as disclosed in Lucchetti L, Cappozzo A, Cappello A, Dela Croce U. Skin movement artifact assessment and compensation in the estimation of knee-joint kinematics. J. Biomech. 1998 November; 31(11):977-84, and Cereatti A, Della Croce U, Cappozzo A. Reconstruction of skeletal movement using skin markers: comparative assessment of bone pose estimators. J Neuroengineering Rehabil. 2006 Mar. 23; 3:7. These teachings suggest that optimal mounting of sensors (or sensor arrays) is critical to minimize skin movement artifacts. For the purpose of describing this invention it is assumed that those skilled in the art would employ such optimal mounting techniques to reduce skin movement artifact introduced into the surface mounted sensors' measurements. Thus we continue our discussion focusing on the basic mathematical transformation between sensor and skeletal systems.

An approach to quantifying these transformations was disclosed in Riley P O, Mann R W, Hodge W A. Modelling of the biomechanics of posture and balance. J. Biomech. 1990; 23(5):503-6. for use with a camera system that tracks clusters (or arrays) of markers on rigid plates secured to the body segments. A method employing a set of hand-held 6-DOF “pointer” arrays was used during a static standing trial (subject stands perfectly still in a controlled posture) to reference the sensor system to the skeletal system for each body segment.

Others, such as Cappozzo A, Cappello A, Della Croce U, Pensalfini F. Surface-marker cluster design criteria for 3-D bone movement reconstruction. IEEE Trans Biomed Eng. 1997 December; 44(12):1165-74, and Andriacchi T P, Alexander E J, Toney M K, Dyrby C, Sum J. A point cluster method for in vivo motion analysis: applied to a study of knee kinematics. J Biomech Engng. 1998; 120:743-749 have taught how to acquire these transformations for clusters of skin mounted markers (placed upon various anatomical landmarks) as well. It is worth noting that considerable effort has been taken to develop reliable models of skeletal motion when markers are placed directly on the skin as “deformable” clusters. The deformability is assumed related to skin motion artifact and thus can be predicted and removed to improve joint center estimates, as taught by Lu T-W, O'Connor J J. Bone position estimation from skin marker co-ordinates using global optimization with joint constraints. J. Biomech. 1999; 32; 129-134 and validated by Roux E, Bouilland S, Godillon-Maquinghen A.-P, Bouttens D. Evaluation of the global optimisation method within the upper limb kinematics analysis. J. Biomech. 2002; 35:1279-1283; and further refined by Reinbolt J A, Schutte J F, Fregly B J, Koh B I, Haftka R T, George A D, Mitchell K H. Determination of patient-specific multi-joint kinematic models through two-level optimization. J. Biomech. 2005; 38:621-626.

But it is also worth noting that this form of “sensor artifact” is not due to sensor slippage, since the skin mounted markers can only wobble, not slip, relative to one another. Wearable sensors for remote monitoring have the added disadvantage of slippage in addition to skin related “wobble”, and thus a different approach is needed to more generally tackle the problem. But independent of the approach taken the overall mathematical step is the same: to determine the position and orientation, or “pose”, of the sensor coordinate system with respect to the skeletal coordinate system. As discussed above, the relative pose of one system with respect to another is generally expressed mathematically as a transformation matrix. Because this step is essentially a calibration step, we can also refer to this matrix as a calibration matrix.

Once a calibration matrix has been determined for each sensor and skeletal segment, skeletal segments' poses in space are easily determined from the sensors' poses in space during arbitrary human postures and movements. Once the skeletal segments' poses are known in space, basic relative motion principles for rigid bodies known to those skilled in the art can be applied to compute the locations of joint centers between adjacent skeletal segments. For example, Riley et al (1990) teach how to use a chair rise trial (employing a linear range of motion of the knee and hip) to establish knee and hip joint centers of rotation in the sagittal plane. The joint centers describe the point or axis about which one skeletal segment rotates with respect to the other, and are of great interest in the field of movement science for both modeling and analysis of human movement, as well as for clinically relevant applications such as monitoring or diagnosing joint injuries or degenerative joint diseases.

The technique cited above for locating joint centers, as well as other techniques published by those skilled in the art, may be applied, in most circumstances, to any 6-DOF sensor system. The general limitation of the above calibration approach, citing again Riley as an example, is that a separate set of instrumentation (eg. hand-held pointers or instrumented calibration frame) is often required to gather the data necessary to compute the sensor-to-segment transformations. Requiring a separate set of calibration instruments may not be suitable for remote motion sensory systems applied in non-laboratory (real world) human body segment tracking applications.

Other calibration procedures, such as those that rely on precise positioning of skin markers on anatomical landmarks, may also not be suitable for extended wear motion tracking with MEMS type sensors. Without accurate instrumentation to perform this calibration approach, and a general inability to control the position of the sensors on the body when applied in minimally or unsupervised environments, estimation of the calibration matrices may be subject to considerable error. These errors result in non-physiologic skeletal motions, causing for example adjacent bones to unnaturally distract or impinge when they move relative to one another.

In addition, should one of the body mounted sensors shift in its position relative to the underlying skeleton (“slippage”), current teachings suggest that the calibration instruments must then be used again to re-establish the calibration matrix. This of course assumes that the sensor slippage is actually detected during data collection, which based on current teachings must be done visually.

U.S. Pat. No. 5,316,017 issued in 1994 discloses a glove having double-axis sensors in the form of traducers to measure joint movements.

U.S. Pat. No. 5,533,531 issued in 1996 discloses a method for electronically aligning a sensor having two nonparallel axes of measurement and being mounted in a garment, so as to be positioned proximate to a joint's first and second axes respectively. The method involves a calibration step where one member on one side of the joint, the wrist for example, is held in a fixture while the other member is moved and initial calibration measurements are taken.

U.S. Pat. No. 5,791,351 issued in 1998 describes a motion measuring apparatus using potentiometers connected together by mechanical linkages. Rotary potentiometers are attached to the joints of the wearers and calibration consists of physically aligning each sensor along the axis of rotation of the respective joint (column 5, lines 10-13).

U.S. Pat. No. 5,826,578 issued in 1998 is a parent application of U.S. Pat. No. 5,791,351 mentioned above and discloses basically the same information.

U.S. Pat. No. 6,050,962 issued in 2000 discloses a device for measuring the joint angle of an articulated body. The sensors used are of the elongated resisting bend type, providing a voltage that is proportional to the alignment of their ends. The sensors are thin, flexible strips that include two variable-resistance elements. The sensors measure bone-to-bone angular orientation. Matrix manipulation and iterative approach are used to determine the position and orientation of one end of an articulated mechanism assembly with respect to the other. (See column 9, lines 35-42 and associated text).

U.S. Pat. No. 6,428,490 issued in 2002 is a continuation of the U.S. Pat. No. 6,050,962 mentioned above.

U.S. Pat. No. 6,127,672 issued in 2000 discloses a motion measuring device, commonly referred to as a shape tape and in column 6, lines 53-56, “This shape measuring tool may be coupled over all or part of its extent by constraining means to a portion of a body or object, the location, shape or orientation in space of which is to be measured.” (column 6, lines 63-68) “It is sufficient for at least one portion of the sensor to be attached to a body for the location and orientation of that portion of the body to be determined with respect to a reference to a reference point elsewhere on the sensor.” (column 7, lines 7-24) “Every sensor's location, and orientation, can be determined with respect to other sensors by inter-referencing the positions of the intervening sensors.

U.S. Pat. No. 6,692,447, issued in 2004 discloses a method to determine the position of the knee joint and the hip joint on a person, using an optical marker which is affixed to the tibia of that person, and a camera. The leg with the marker affixed to it is moved in a pedaling motion and positions of the marker are recorded.

U.S. Pat. No. 6,997,882, issued in 2006 discloses a device and a method for acquiring 6-DOF data regarding a person's movement, position, and orientation in three-dimensional space. The document describes a method to calibrate and re-calibrate two accelerometer sensors relative to a reference Cartesian frame.

US Patent Publication Application No. 2005/0143676, published in 2005, discloses a method for calibrating a device for studying knee kinematics. In this method, a first marker is mounted on the femoral portion of the leg and a second marker is mounted on the tibia1 portion of the leg. The leg is moved in a kicking motion and the position and orientation of the markers are digitized. A position calculator 42 is used to determine the axis of the knee. (Paragraph 0042).

CA Patent No. 1,208,747, issued in 1986 discloses a system for calibrating the space coordinates of a robot gripper in six degrees of freedom. This document explains that errors in positioning the robot's gripper may occur due to drift in some of the six coordinate directions. Therefore compensation of the robot coordinates at suitable intervals is a requisite. The method disclosed includes moving a gripped object in a fixture having several sensors. The gripper is moved repeatedly until an error in the sensor readings is canceled.

CA Patent Application Serial No. 2,234,537, published in 1995 discloses a range-of-motion-arm that has 6 degrees of freedom. The arm is capable of measuring the movement of one body member relative to a fixed attachment on another part of the body.

CA Patent Application Serial No. 2,246,290, published in 1997 discloses a system to determine the location of a probe inside a patient's body. The system uses three field transducers. The relative position of the field transducers are redetermined periodically and the position of the probe is redetermined periodically based on the redetermined relative position of the field transducers. This system permits the mounting of the field transducers of movable elements of the body, as for example, on the surface of the abdomen or thorax. Although this document describes a step of calibration at interval to compensate for sensor movement, it does not suggest or describe the present method for calibrating sensor positions.

CA Patent Application Serial No. 2,427,186, published in 2001 describes a similar device as in the US Patent Publication 200510143676, mentioned above. The document describes a harness for supporting three sensors on the femur of a person and one attachment bar for mounting another sensor to the tibia of the person. The system provides position and orientation information of the femur and tibia in space, and the position and orientation of the sensors with respect to one another. The location of the sensors is detected at specific time intervals.

The present invention will address these limitations. We anticipate that the teachings of this invention will be of interest to those developing and utilizing wearable sensor systems (and motion lab sensor systems as well) for human motion tracking.

### SUMMARY OF THE INVENTION

The present invention addresses the above identified drawbacks by providing a method that is capable of robust, accurate, and reliable location of skeletal coordinates systems with respect to the segment mounted sensors without the need for additional instrumentation, referred to herein as the “method”. The method can be used in the laboratory setting in conjunction with the teachings of other others in the field, but more importantly will enable extended wear of wireless remote 6-DOF skeletal movement capture of a human or animal. Fields of application of this technology may include, but are not limited to physical therapy rehabilitation services; laboratory and field (remote) human movement science; high performance athletics; military training and simulation; animation library development; advanced gaming.

The method comprises a protocol for mounting of the sensor devices, a set of initial calibration tests, and an analytical approach that utilizes these data for arriving at the sensor-to-segment transformations. The method acquires data from the body mounted motion sensor devices as taught by others in the field. Data from the devices is then processed according to the present teachings to arrive at an accurate representation of skeletal motion that can then be used for sophisticated biomechanical analyses and simulations, or used to build scaleable animation libraries of complicated human movements, to list but a few examples.

An embodiment of the invention provides a method for locating a system of motion sensors on a human or other animal body for capture of movement time history, comprising the steps of:

determining mathematical transformation matrices between coordinate systems of sensors strategically positioned on a person's body and skeletal coordinate systems to produce a human body kinematic model;

refining the transformation matrices of the human body kinematic model to minimize anatomical joint gap error; and

monitoring the anatomical joint gap to detect and correct for sensor slippage during data collection.

A further understanding of the functional and advantageous aspects of the invention can be realized by reference to the following detailed description and drawings.

### BRIEF DESCRIPTION OF DRAWINGS

The aforementioned features and advantages, and other features and aspects of the present invention, will be understood with reference to the following and accompanying drawings; wherein:

FIG. 1 illustrates a schematic block diagram of the overall method;

FIG. 2 illustrates a schematic block diagram of the method for mounting the sensor system on the human body;

FIG. 3 illustrates a schematic block diagram of the sensor system calibration stage;

FIG. 4 illustrates a schematic representation of the sensor-to-segment coordinate systems used in the calibration stage;

FIG. 5 illustrates a schematic representation of the sensor-to-segment transformations of the upper extremity;

FIG. 6 illustrates a schematic representation of the dynamic calibration stage for optimizing the human body model;

FIG. 7 illustrates a schematic block diagram of the data capture and processing stage; and

FIG. 8 illustrates a schematic block diagram of the sensor slippage monitoring and correction stage.

### DETAILED DESCRIPTION OF THE INVENTION

Generally speaking, the systems described herein are directed to methods for calibrating sensor positions in a human or animal movement measurement and analysis system. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to methods for calibrating sensor positions in a human movement measurement and analysis system.

As used herein, the term “about”, when used in conjunction with ranges of dimensions, angles or other physical properties or characteristics, is meant to cover slight variations that may exist in the upper and lower limits of the ranges as to not exclude embodiments with concentrations slightly above or below those recited herein. It is not the intention to exclude embodiments such as these from the present invention.

The illustrative embodiment of the present invention provides method for the calibration of body mounted sensors' positions and orientations relative to the skeletal frame, for analysis of kinematics and kinetics of human movement. The method is independent of the means by which 6-DOF kinematic measurements of body mounted sensors are acquired. Data captured by the system being employed are used as inputs to the method of the present teachings. The method of the present teachings utilizes a protocol for positioning the person for static calibration of the sensor-to-segment transformations, following by a protocol involving dynamic limb movements for fine-tuning the skeletal model. Once the sensor-to-segment transformation are established, sensor data are collected and processed, as taught by others, to arrive at skeletal motions. The method presented herein also teaches how to monitor the sensor data to detect and compensate (correct) for sensor slippage. The method may be used for both humans and animals but in the following description the method is exemplified with reference to the human body.

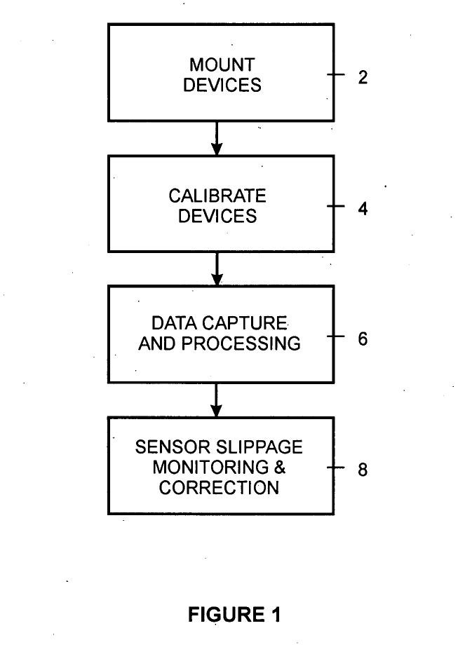

FIG. 1 is a schematic block diagram of the method according to the teachings of the present invention. The present invention relies on the mounting of the sensor devices (“system”) in step 2 upon a person in a precise and specific manner consistent with the operation of the system's devices. This is followed by the calibration step 4, where the kinematic model of the human body for the person is created. Once satisfactory model error tolerances have been reached, the system is used in live capture mode and skeletal kinematic data are computed and stored in step 6. Finally, the data acquired during the session are used to monitor and correct for sensor slippage in step 8.

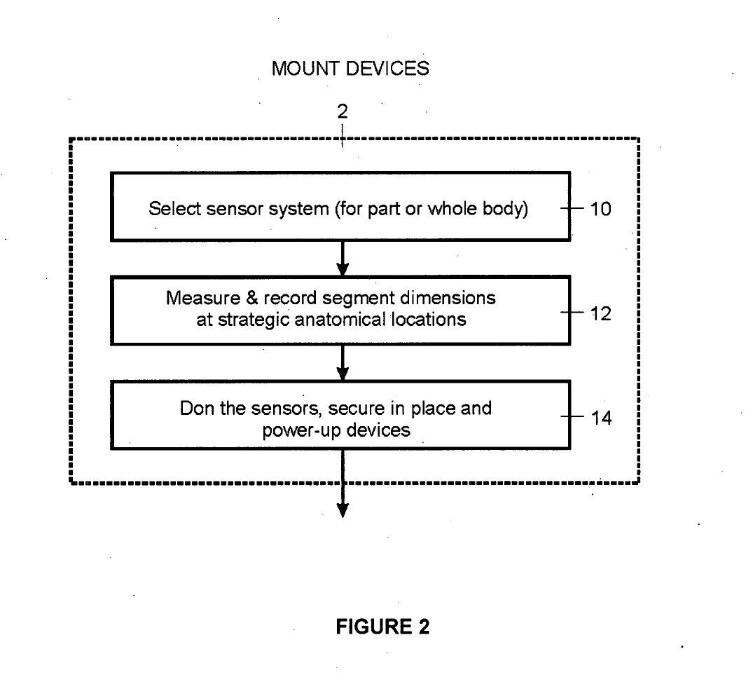

FIG. 2 is a schematic block diagram of step 2, for mounting the devices of the system on the person. First, a combination of sensors are selected that meets the needs of the task being monitored in step 16 of FIG. 1. The next step 12 of FIG. 2 is to acquire a set of anatomical measurements that will be used to develop the skeletal model. These may consist of various anatomical measurements, selected according to the teachings of others, such as Riley et al. (1990). The garment(s) and/or cuff(s) with the motion sensors are donned by the user and the system is powered up in step 14 of FIG. 2, as taught by others in the field.

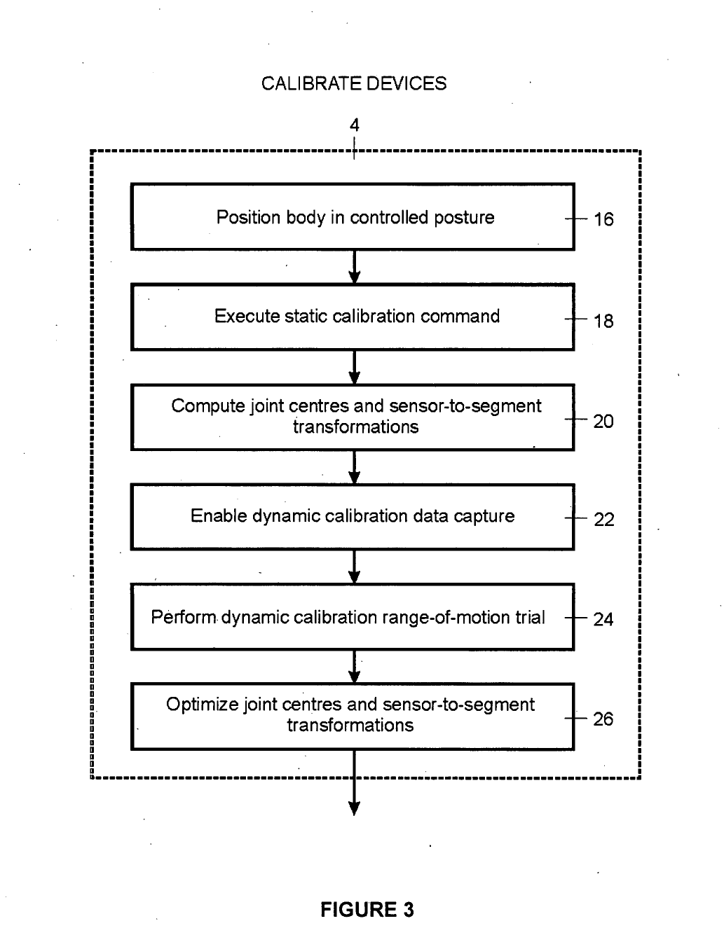

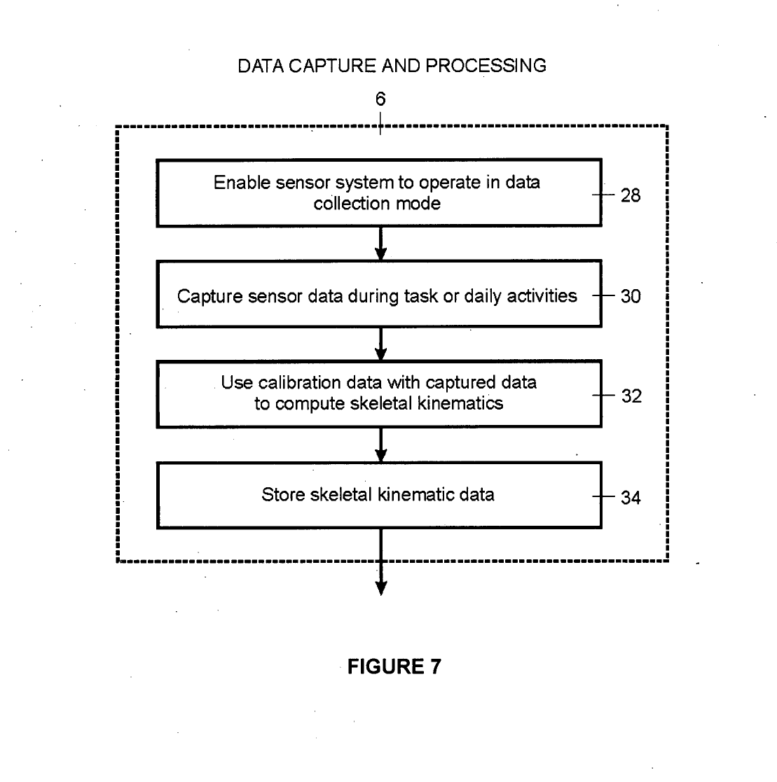

Recall that step 4 of FIG. 1 showed the step consisting of the calibration methods. This step is shown in more detail in the schematic block diagram of FIG. 3. Calibration commences with positioning the body in a known and controlled posture in step 16 of FIG. 3. This step requires the person wearing the sensors to either stand erect with feet spaced at a specific distance apart and arms hanging vertically or (for those with disabilities) to sit briefly in a special straight backed, level seated chair. In static calibration mode (standing or sitting), data are acquired from the sensors for a specified time in step 18 of FIG. 3, and used with the anatomical data to compute and estimate the positions of the skeleton relative to the segmented mounted sensors in step 20 of FIG. 3, see Data Processing step shown in FIG. 7 for more details.

Once static calibration is complete, the person then proceeds (depending on which body segments have sensors mounted on them) to a brief dynamic calibration session. In this step, the user first initializes the dynamic calibration protocol in step 22 of FIG. 3, and then performs a series of range-of-motion trials to acquire information about the relative movements of the body segments in step 24 of FIG. 3. These could consist of any or all of the following: for the arm: shoulder abduction/adduction and flexion/extension, elbow flexion/extension, arm pronation/supination (rotation of the forearm), and wrist flexion/extension; for the leg: hip abduction/adduction and flexion/extension, knee flexion/extension, and ankle dorsiflexion/plantarflexion. For the whole-body: in addition to above, trunk flexion/extension and neck flexion/extension, etc.

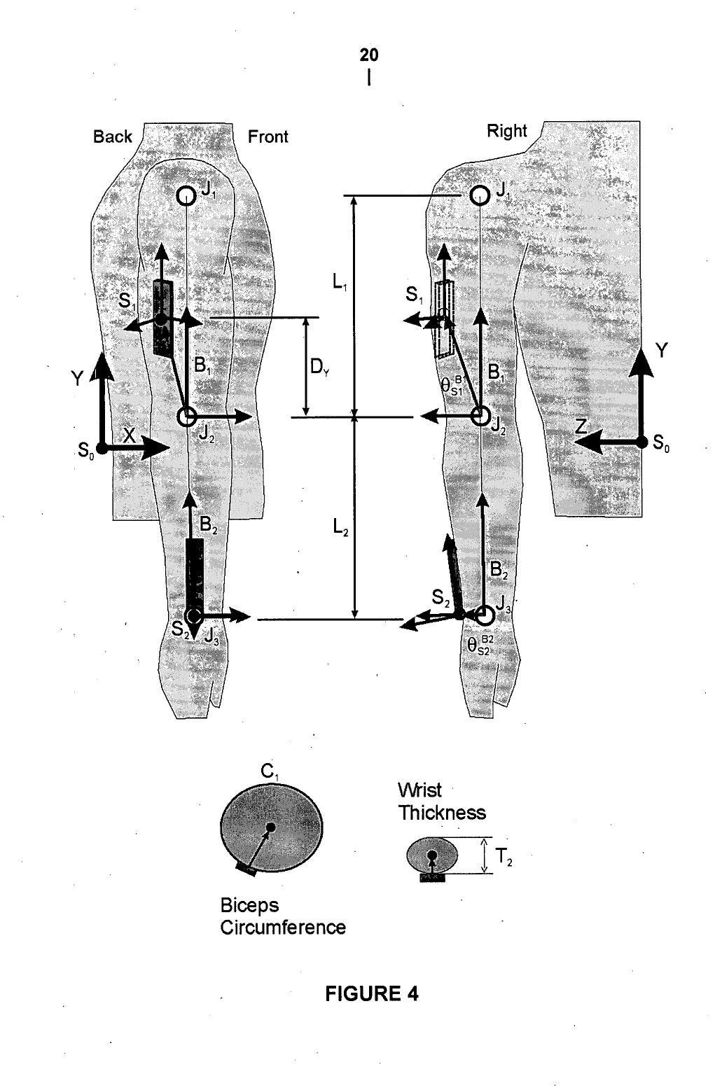

The method taught with the present invention shows how these data are used to fine-tune the skeletal model by computing and minimizing the gap at skeletal joints in step 26 of FIG. 3. This is accomplished by re-computing the sensor-to-segment transformations iteratively until the joint gaps are below a specified threshold and measured segments lengths are maintained within a specific threshold. This is based on the fact that computed joint centers should be such that skeletal segments do not distract or impinge beyond known physiologic limits. FIGS. 4 to 6 show specific analytical steps used using the elbow as an example (it will be appreciated that the method disclosed herein may be used with any body segments connected by an anatomical joint).

As shown in FIG. 4, the long axis of the upper arm passes through center of circles J₁ and J₂ (biceps cross-section) u₁ at distance r₁ from the sensor S₁ along the −z_{S1} axis.
u₁=s₁+[0,0,−r₁][φ_{S1}]
The elbow J₂ is located a distance D_{Y} below u₁ along −y_{B1} axis
J₂=u₁+[0,−D_{Y},0]
The shoulder J₁ is located a distance L₁ above J₂ along the +y_{B1} axis
J₁=J₂+[0,L₁,0].
The orientation of the upper arm coordinate frame is assumed [0,0,0] degrees, thus its rotation matrix is an identity matrix.

$${ϕ}_{B 1} = [ \begin{matrix}1 & 0 & 0 \\ 0 & 1 & 0 \\ 0 & 0 & 1\end{matrix} ]$$

Now the sensor-to-segment transformations for the upper arm can be computed.
The relative rotation matrix: θ_{S1}^{B1}=[φ_{S1}]^{T}[φ_{B1}]
Shoulder position in sensor coordinates: P_{S1}^{J1}=(J₁−S₁)φ_{S1}^{T}
Elbow position in sensor coordinates: P_{S1}^{J2}=(J₂−S₁)φ_{S1}^{T}

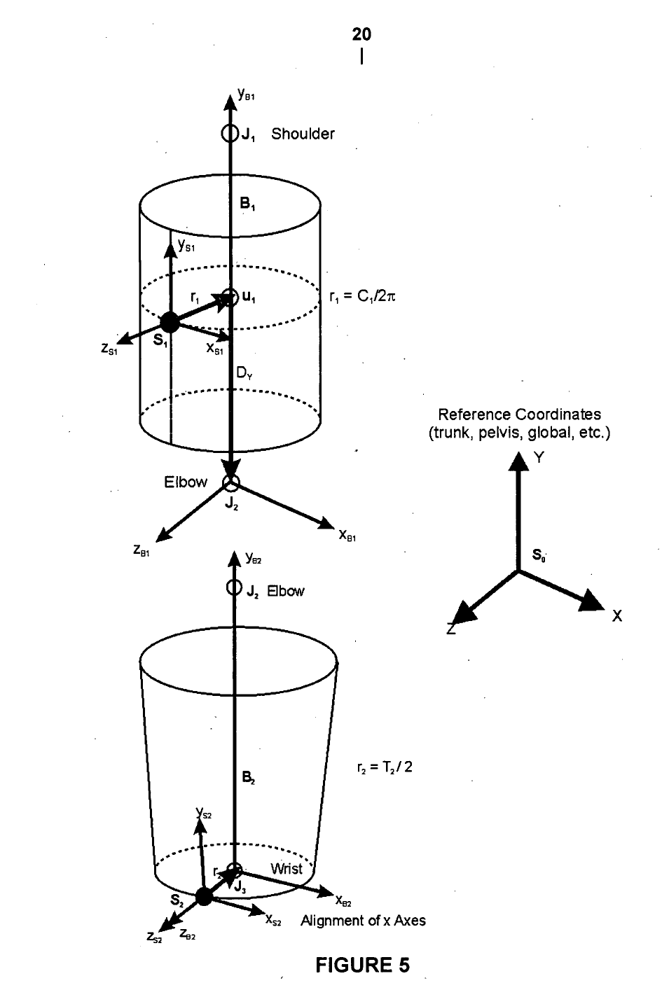

FIG. 5 (top) shows how shoulder and elbow are located relative to the upper arm sensor S₁. Next the wrist center is located from the forearm sensor located on the dorsal wrist surface, as shown in FIG. 5 (bottom).
J₃=s₂+[0,0,−r₂][φ_{S2}]
Let

$${ϕ}_{B 2} = [ \begin{matrix}{C}_{xx} & {C}_{xy} & {C}_{xz} \\ {C}_{yx} & {C}_{yy} & {C}_{yz} \\ {C}_{zx} & {C}_{zy} & {C}_{zz}\end{matrix} ]$$

The x-axis of the forearm system B₂ is assumed to be co-linear with the x-axis of the sensor system S₂. Therefore Cₓ={Cₓₓ, C_{xy}, C_{xz}} is taken from the sensor rotation matrix φ_{S2}. The y-axis direction vector is found from

$${C}_{y} = \{ \frac{{x}_{{J}_{2}} - {x}_{{J}_{3}}}{\overline{{J}_{2} - {J}_{3}}} , \frac{{y}_{{J}_{2}} - {y}_{{J}_{3}}}{\overline{{J}_{2} - {J}_{3}}} , \frac{{z}_{{J}_{2}} - {z}_{{J}_{3}}}{\overline{{J}_{2} - {J}_{3}}} \}$$

And the z-axis direction vector can be located by the cross-product C_{z}=Cₓ×C_{y}.

Now the sensor-to-segment transformations for the forearm can be computed.
The relative rotation matrix: ƒ_{S2}^{B2}=[φ_{S2}]^{T}[φ_{B2}]
Elbow position in sensor coordinates: P_{S2}^{J2}=(J₂−S₂)[φ_{S2}]^{T}
Wrist position in sensor coordinates: P_{S2}^{J3}=(J₃−S₂)[φ_{S2}]^{T}

Once the above-sensor-to-segment transformations have been stored (in a separate file or database, and/or written to a header of a data file), for any arbitrary trial (arm activity) the 6-DOF position and orientation of the skeletal body segment can be found, by inverse transformation using the sensor-to-segment transformation matrices.

For upper arm segment:
Shoulder position in global coordinates: J₁=S₁+P_{S1}^{J1}φ_{S1}
Elbow position in global coordinates: J₂⁽¹⁾=S₁+p_{S1}^{J2}φ_{S1}
Rotation matrix of upper arm: φ_{B1}=φ_{S1}θ_{S1}^{B1}

For forearm segment:
Elbow position in global coordinates: J₂⁽²⁾=S₂+P_{S2}^{J2}φ_{S2}
Wrist position in global coordinates: J₃=S₂+P_{S2}^{J3}φ_{S2}
Rotation matrix of forearm: φ_{B2}=φ_{S2}θ_{S2}^{B2}

Once the orientation of the upper arm and forearm is found in 3D space, we can then compute elbow angular displacements using the relative rotation matrix. θ_{J2}=[φ_{B1}][φ_{B2}]^{T}, and which is easily solved for flexion/extension α, abduction/adduction β, and internal/external rotation γ, angles. This can be done using a Cardan 3-1-2 decomposition of the rotation matrix, as embodied herein, or other matrix decomposition method known to those skilled in the art.

Joint Center Determination

As an illustrative example of one possible embodiment, consider the human elbow joint. The elbow has essentially two rotational degrees of freedom: flexion-extension and internal-external rotation. Unfortunately (for the modeler), this motion is facilitated by the two forearm bones, which can move relative to one another. The elbow joint model is considerably simplified if we assume it behaves as a 2-DOF joint with axes of rotation passing through a fixed position on both segments. This requires that both fixed points on each segment are always coincident (the center of rotation) in space.

The 6-DOF tracking of upper arm and forearm gives us a convenient opportunity to fine tune the anatomical model of the elbow. Our initial measurements for locating the elbow was only to put the model through its first iteration. Surely when we perform a range of motion task, the elbow on the upper arm J₂⁽¹⁾ will not perfectly coincide with the elbow on the forearm J₂⁽²⁾. The degree of mismatch tells us the degree we erred in finding the joint center of rotation from our simple anatomical model.

We can improve this model, however, if we simply apply an iteration approach to finding the anatomical model which closes the apparent “joint gap”. The procedure is as follows:

Model Refinement

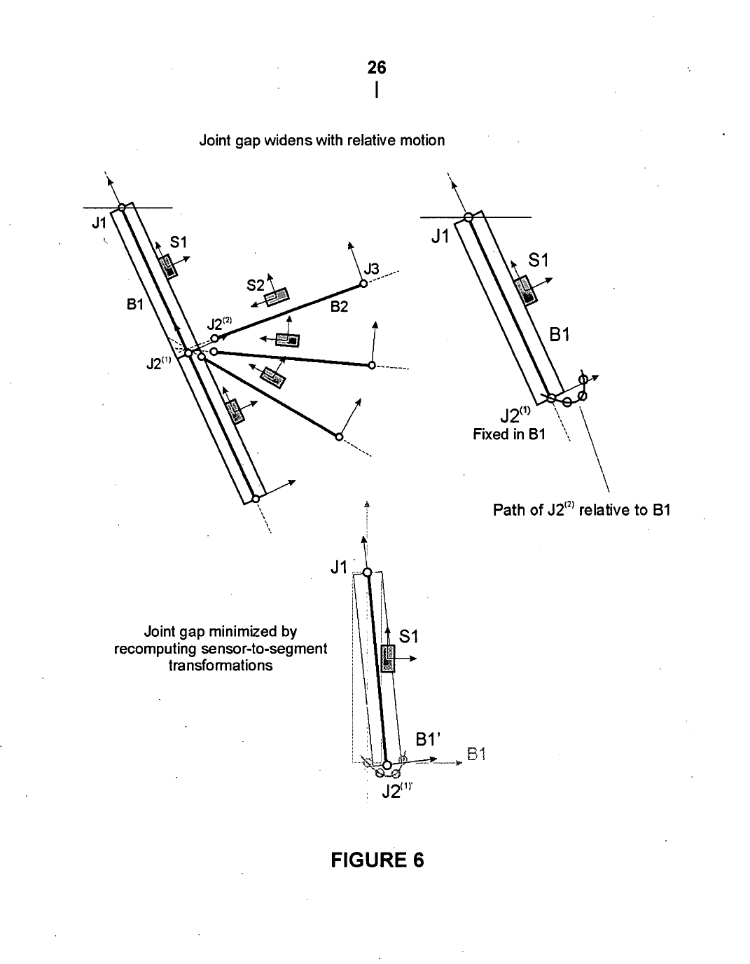

After calibration, the segment coordinate axes B and joint centers (Jᵢ and Jᵢ₊₁) can be expressed in Sensor S coordinates. For multiple connected segments, each with a calibrated sensor, the endpoints of each segment can be found in global space. The time history of movement of the segments in global space is illustrated in FIG. 6. It is the joint gap that must be minimized.

One way this might be done is to adjust the segment coordinate system B relative to S to minimize the joint gap. Since the proximal and distal joint centers define the B long (y) axis, we are essentially just manipulating the segment long axes (we can redo the cross-products to get the modified x and z axes later) to find the best joint center location.

Assume we look at the relative movement of segment B2 with respect to B1. The path of J2 on segment B2 (J2⁽²⁾) would trace a path relative to B1. It would coincide with the fixed center J2 on B1 (J2⁽¹⁾) only once—at neutral position.

Now we simply average the path of J2⁽¹⁾=J2^{(1)′} and this becomes the new origin of B1′ (and passing through J1). We then re-compute the segment B1 axes, and compute their position and orientation relative to S1. Now we do the same exercise, except for the distal segment's J2 location. Get average J2⁽²⁾=J2^{(2)′} to define new B2 relative to S2. If we now re-run the analysis with the modified calibration, our joint gap should be smaller.

The above can be run multiple times until the gap is minimized (for example, when changes less than a specified threshold (eg. 1 mm) occur with each additional iteration).

Analytical Procedure

1. Collect range of motion data (after static trial is done and applied)

2. Using sensor-to-segment transformations:

a. Compute trajectory of elbow center on upper arm J₂⁽¹⁾ in global coordinates

b. Compute trajectory of elbow center on forearm J₂⁽²⁾ in global coordinates

3. Compute the RMS distance eᵢ between J₂⁽¹⁾ and J₂⁽²⁾

4. Transform J₂⁽²⁾ into B₁ coordinates=J₂^{(2)B1}

5. Find the mean of the excursion of J₂^{(2)B1}: this becomes the new location of J₂^{(1)′} on B₁.

6. Transform J₂⁽¹⁾ into B₂ coordinates=J₂^{(1)B2}

7. Find the mean of the excursion of J₂^{(1)B2}: this becomes the new location of J₂^{(2)′} on B₂.

8. From J₁-J₂^{(1)′} and J₂^{(2)′}-J₃ re-compute the sensor-to-segment transformations.

9. Repeat steps 2 and 3.

10. Compare eᵢ to previous eᵢ₋₁. If less than a set threshold (eg. 1 mm), no further improvement expected. If greater than a set threshold, steps 4-10 are repeated.

11. Store the final sensor-to-segment transformations.

Now recall that step 6 of FIG. 1 shows the step consisting of active data collection mode. This step 6 is shown in more detail in the schematic block diagram of FIG. 7. Once the device(s) are calibrated, the system is switched to active mode in step 28. Sampling rates and data storage protocol are determined by the data collection system being used, as taught by those in the field. During data collection mode the sensors capture data during tasks or activities of daily living as desired by the user in step 30, and the sensor data transformed into skeletal movement kinematics using the stored sensor-to-segment calibration matrices in step 32. Finally, the skeletal kinematics are stored by the system in step 34.

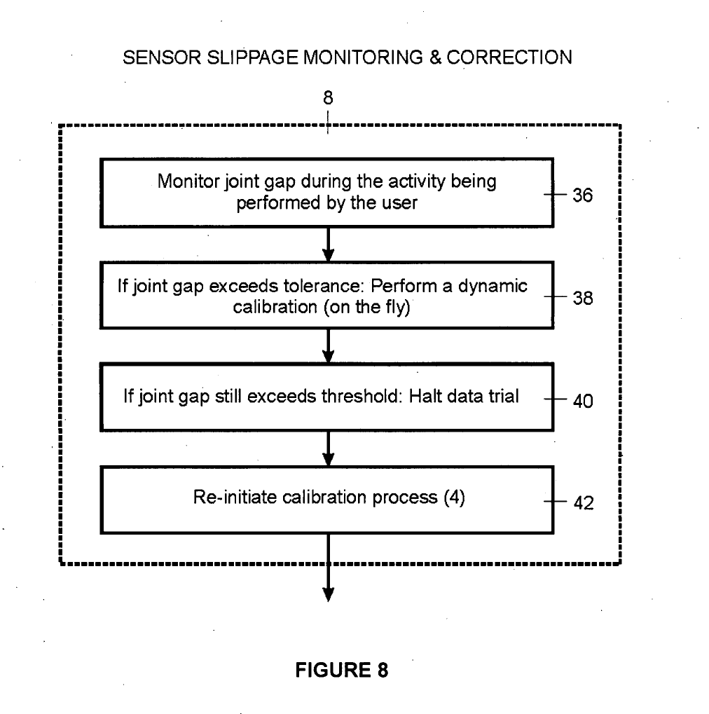

Finally recall that step 8 in FIG. 1 showed the step consisting of monitoring and correcting for sensor slippage. This step is shown in more detail in the schematic block diagram of FIG. 8. The first step 36 is to monitor the joint gap magnitudes of all joints being measured during the data collection trial. If at any point in time the joint gap magnitude exceeds a given tolerance for a given period of time, the method we taught above describing the dynamic calibration in step 24 of FIG. 3 and FIGS. 4 to 6 is automatically initiated and corrections made to the segment-to-sensor transformations “on the fly” in step 38 of FIG. 8. If the joint gap magnitude does not improve to tolerances with the above step, the data collection trial is halted in step 40 of FIG. 8. At this point the calibration step 4 of FIG. 1 comprises of steps 16 through 26 in FIG. 3 is re-initiated as required.

It is believed that this document complies with the requirements of 35 U.S.C. 112, as it provides sufficient information to enable those skilled in the art to build and use this invention.

Numerous modifications and alternative embodiments of the invention will be apparent to those skilled in the art in view of the forgoing description. Accordingly, this description is illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

### BIBLIOGRAPHY

Lucchetti L, Cappozzo A, Cappello A, Della Croce U. Skin movement artifact assessment and compensation in the estimation of knee-joint kinematics. J. Biomech. 1998 November; 31(11):977-84.
Cereatti A, Della Croce U, Cappozzo A. Reconstruction of skeletal movement using skin markers: comparative assessment of bone pose estimators. J Neuroengineering Rehabil. 2006 Mar. 23; 3:7.
Riley P O, Mann R W, Hodge W A. Modelling of the biomechanics of posture and balance. J. Biomech. 1990; 23(5):503-6.
Cappozzo A, Cappello A, Della Croce U, Pensalfini F. Surface-marker cluster design criteria for 3-D bone movement reconstruction. IEEE Trans Biomed Eng. 1997 December; 44(12):1165-74.
Andriacchi T P, Alexander E J, Toney M K, Dyrby C, Sum J. A point cluster method for in vivo motion analysis: applied to a study of knee kinematics. J Biomech Engng. 1998; 120:743-749.
Lu T-W, O'Connor J J. Bone position estimation from skin marker co-ordinates using global optimisation with joint constraints. J. Biomech. 1999; 32; 129-134.
Roux E, Bouilland S, Godillon-Maquinghen A.-P, Bouttens D. Evaluation of the global optimisation method within the upper limb kinematics analysis. J. Biomech. 2002; 35:1279-1283.
Reinbolt J A, Schutte J F, Fregly B J, Koh B I, Haftka R T, George A D, Mitchell K H. Determination of patient-specific multi-joint kinematic models through two-level optimization. J. Biomech. 2005; 38:621-626.
Reinbolt J A, Haftka R T, Chmielewski T L, Fregly B J. A computational framework to predict post-treatment outcome for gait-related disorders, Med Eng Phys. 2007, In-press: doi:10.1016/j.medengphy.2007.05.005

Therefore what is claimed is:

1. A method for locating a system of motion sensors on a human or other animal body for capture of movement time history, comprising the steps of:
1a) determining mathematical transformation matrices between coordinate systems of sensors strategically positioned on a human or other animal body and skeletal coordinate systems to produce a kinematic model of the human or other animal body;
1b) refining the transformation matrices of the kinematic model to minimize anatomical joint gap error; and
1c) monitoring the anatomical joint gap to detect and correct for sensor slippage during data collection.

2. The method of claim 1, wherein said sensors are first and second sensors, and wherein step 1a) includes the following steps:
2a) strategically positioning said first and second sensors to first and second articulated segments connected by said anatomical joint, respectively;
2b) taking physical measurements on said articulated segments and said first and second sensors for locating each of said first and second sensors in their respective segment coordinate reference frames; and
2c) using said physical measurements to produce a sensor-to-segment transformation matrix.

3. The method of claim 2 wherein said first and second sensors are strategically positioned by being physically mounted on said first and second articulated segments in strategically selected positions.

4. The method of claim 2 wherein said first and second sensors are strategically positioned by being physically mounted, on or within, a suit or other wearable garment and worn by the human or other animal body such that when being worn the first and second sensors are in pre-selected positions on said first and second articulated segments.

5. The method of claim 2, wherein step 2b) includes the following steps: performing a static calibration step by collecting kinematic data first in a static calibration step by having the person or other animal wearing the sensors stand or sit in a pose without moving while data are acquired from the sensors for a specified time and estimating from said acquired data the positions of the skeleton relative to the segment mounted sensors.

6. The method of claim 5, wherein step 2b) includes the following steps: collecting kinematic data for said kinematic model in a dynamic calibration step by
6a) moving each of said articulated segments through a range of motion, and simultaneously recording positions, orientations and displacements of each of said sensors;
6b) using said positions, orientations and displacements of said first sensor, calculate a first position, alignment and trajectory of said anatomical joint relative to said first sensor;
6c) using said positions, orientations and displacements of said second sensor, calculate a second position, alignment and trajectory of said anatomical joint relative to said second sensor;
6d) comparing the first and second anatomical joint positions, alignments and trajectories, and defining an anatomical joint gap;
6e) if said anatomical joint gap is larger than a specific value or tolerance, defining by iteration, sensor-to-segment transformation matrices that minimize said anatomical joint gap;
6f) if said anatomical joint gap remains outside the desired tolerance for a specified number of iteration attempts, repeat steps as defined in claim 2 followed by those of claim 5; and
6g) when said anatomical joint gap is within tolerance, proceed with the gathering of kinematic data relative to said articulated segments.

7. The method of claim 5, wherein step 1c) includes the following steps:
7a) while collecting kinematic data for said kinematic model, said anatomical joint gap is monitored periodically between articulated segments to detect sensor slippage;
7b) if said joint gap exceeds a specified threshold, repeat steps as defined in claim 5 for the articulated segments in question;
7c) if said anatomical joint gap continues to exceed threshold, repeat steps as defined in claim 2 followed by those of claim 5;
7d) when said anatomical joint gap is within tolerance again, proceed as before with the gathering of kinematic data relative to said articulated segments.

8. The method according to claim 7 wherein said body is a human body and wherein said first and second articulated segments connected by a joint is an upper arm and lower arm connected by an elbow joint.

9. The method according to claim 7 wherein said body is a human body and wherein said first and second articulated segments connected by an anatomical joint is an upper leg and lower leg connected by a knee joint.

10. The method according to claim 7 wherein said body is a human body and wherein said first and second articulated segments connected by an anatomical joint is a lower leg and foot connected by an ankle joint.

11. The method according to claim 7 wherein said body is a human body and wherein said first and second articulated segments connected by an anatomical joint is an upper leg and lower trunk of the torso or pelvis connected by a hip joint.

12. The method according to claim 7 wherein said first and second articulated segments connected by an anatomical joint are any two segments of the human or other animal body connected by an anatomical joint.
